(19) United States
(12) Patent Application Publication
(10) Pub. No.: US 2024/0380228 A1
(43) Pub. Date: Nov. 14, 2024

(54) Interface Module for Operating an Electrical Consumer with at Least One Exchangeable Energy Storage Device and a Method for Controlling the Electrical Consumer by Means of the Interface Module

(71) Applicant: Robert Bosch GmbH, Stuttgart (DE)

(72) Inventors: Uwe Engelfried, Ostfildern (DE); Gerhard Walter, Gerlingen (DE); Helge Kuebler, Aichtal (DE)

(21) Appl. No.: 18/687,758

(22) PCT Filed: Jul. 8, 2022
(86) PCT No.: PCT/EP22/69065

§ 371 Date: Feb. 28, 2024

(30) Foreign Application Priority Data
Sep. 14, 2021 (DE) 10 2021 210 157.7

(51) Int. Cl. H02J 7/00

(52) U.S. Cl. CPC H02J 7/0063; H02J 7/00716; H02J 7/007182; H02J 7/007194

(57) ABSTRACT

An interface module is for operating an electrical consumer of a defined voltage class with at least one exchangeable energy storage device that is directly incompatible with the electrical consumer. The defined voltage class of the electrical consumer corresponds to an integer multiple of a battery voltage of the at least one exchangeable energy storage device, and the interface module has a control or regulating unit that monitors at least one operating parameter of the exchangeable energy storage device and controls an electrical load of the electrical consumer as a function of the monitored operating parameter.

The invention relates to an interface module for operating an electrical consumer of a defined voltage class with at least one exchangeable energy storage device that is directly incompatible with the electrical consumer, and to a method for controlling the electrical consumer by means of the interface module according to the type of invention in the independent claims.

### PRIOR ART

A large number of electrical consumers are operated with rechargeable energy storage devices, which are discharged by the electrical consumer and can be recharged using a charger. Typically, such energy storage devices consist of a plurality of energy storage cells interconnected in series and/or parallel in order to achieve a required battery voltage or capacity. A particularly advantageous and quite high power and energy density can be achieved if the energy storage cells are designed as, e.g., lithium ion cells (Li-ion).

In recent years, electric consumers have increasingly replaced their mains-powered counterparts because they enable significantly greater flexibility independent of a stationary energy supply and rechargeable energy storage devices have become more and more powerful, often not only matching but even exceeding the performance of mains-powered consumers. In order to be able to offer the customer the widest possible range of electrical consumers on the one hand and to be able to use an already successful concept of exchangeable energy storage devices, in particular exchangeable battery packs, from a specific manufacturer on the other, different manufacturers of electrical consumers have increasingly joined together to form so-called battery alliances, in which the electrical consumers of the different manufacturers use a common energy storage platform. However, this often results in the problem of incompatibility between the electrical consumers of one manufacturer and the exchangeable energy storage devices of the other manufacturer. It is therefore necessary for the manufacturers of incompatible electrical consumers to adapt their respective devices to the common energy storage platform in order to be able to use them. In some cases, this involves complex and cost-intensive measures, both in terms of the electromechanical interfaces and the consumer's own electronics.

Known from WO 2016/097081 is a power tool which contains a control device and an electromechanical interface device for connecting an exchangeable battery pack to the power tool and for supplying the power tool with an electrical voltage from the exchangeable battery pack. The interface device comprises a first connection point and a second connection point and can be set to at least a first position and a second position. The first connection point can be used to supply the power tool with electrical voltage from a first interchangeable battery pack when the interface device is set in the first position and the second connection point can be used to supply the power tool with electrical voltage from a second interchangeable battery pack when the interface device is set in the second position.

The object of the invention is to provide an interface module for an electrical consumer that enables universal use of a normally incompatible, exchangeable energy storage device on the electrical consumer while complying with all prescribed safety measures.

### Advantages of the Invention

In order to achieve said object, it is provided that the defined voltage class of the electrical consumer corresponds to an integer multiple of a battery voltage of the at least one exchangeable energy storage device and that the interface module comprises a control or regulating unit which monitors at least one operating parameter of the exchangeable energy storage device and controls an electrical load of the electrical consumer as a function of the monitored operating parameter. With particular advantage, not only can otherwise incompatible exchangeable energy storage devices and electrical consumers be connected to each other, it is also possible to effectively prevent damage to the energy storage device and/or the electrical consumer, thereby effectively increasing safety during operation.

In the context of the invention the term “electrical consumers” is, e.g., intended to mean power tools operated with an exchangeable energy storage device, in particular an exchangeable battery pack, for processing workpieces by means of an electrically driven insert tool. The power tool can in this case be designed both as a hand-held power tool, or also as a stationary electric machine tool. Typical power tools in this context include hand or bench drills, screwdrivers, percussion drills, hammer drills, planers, angle grinders, orbital sanders, polishing machines, circular saws, table saws, crosscut saws and jigsaws, or the like. However, measuring devices operated with an exchangeable energy storage device, in particular an exchangeable battery pack, such as rangefinders, laser leveling devices, wall scanners, etc., as well as garden and construction equipment such as lawn mowers, lawn trimmers, branch saws, motor and trench cutters, robot breakers and excavators or the like and household appliances such as vacuum cleaners, mixers, etc. can also be considered as electrical consumers. The invention is also applicable to electrical consumers that are simultaneously supplied with a plurality of interchangeable battery packs in order to achieve a high operating time and/or performance.

The electrical load of the electrical consumer can, e.g., be designed as a brushless DC motor (EC or BLDC motor) controlled by a power output stage using pulse width modulation (PWM). Other inductive, capacitive, and/or resistive loads that can be supplied with energy via the exchangeable energy storage device are also possible. These are well known to the skilled person, so they will not be further addressed herein.

The battery voltage of an exchangeable energy storage device is usually a multiple of the voltage of a single energy storage cell and results from the interconnection (parallel and/or series) of the individual energy storage cells. An energy storage cell is typically designed as a galvanic cell comprising a structure in which a cell pole comes to rest on one end and another cell pole comes to rest on an opposite end. In particular, the energy storage cell comprises a positive cell pole at one end and a negative cell pole at an opposite end. The energy storage cells are preferably designed as lithium-based energy storage cells, e.g., Li-ion, Li-po, Li-metal, or the like. However, the invention can also be applied to energy storage devices comprising Ni—Cd cells, Ni-Mh cells, or other suitable cell types. Common Li-ion energy storage cells with a cell voltage of 3.6 V result in battery voltages of, e.g., 3.6 V, 7.2 V, 10.8 V, 14.4 V, 18 V, 36 V, 54 V, 72 V, etc. Preferably, an energy storage cell is designed as an at least essentially cylindrical round cell, with the cell terminals arranged at the ends of the cylindrical shape. However, the invention does not depend on the type and design of the energy storage cells used, but can instead be applied to any desired energy storage device and energy storage cells, e.g. pouch cells or the like, in addition to round cells.

An electrical consumer that is directly incompatible with the exchangeable energy storage device is understood to mean that the exchangeable energy storage device and the electrical consumer do not have mutually compatible electromechanical interfaces for tool-free connection without additional means and/or that the electrical consumer cannot read out and evaluate the operating data of the exchangeable energy storage device required for safe operation without additional means. Only via compatible electromechanical interfaces can the exchangeable energy storage device then be connected to the electrical consumer without the need for tools. It is therefore particularly advantageous for the interface module to have an electromechanical interface that is compatible with the electromechanical interface of the interchangeable battery pack. In each case, a first of the electrical contacts of the electromechanical interfaces is designed as a power supply contact to which a first reference potential, preferably a supply potential, can be applied and a second of the electrical contacts of the electromechanical interfaces is designed as a power supply contact to which a second reference potential, preferably an ground potential, can be applied.

The electrical circuitry of the exchangeable energy storage devices connected to the interface module is designed in such a way that the defined voltage class of the electrical consumer must correspond to an integer multiple of the battery voltage of a single exchangeable energy storage device. If the interface module comprises a number of electromechanical interfaces for a corresponding number of exchangeable energy storage devices, each energy storage device must essentially have the same battery voltage. With particular advantage, the interface module can compensate for certain voltage deviations between the resulting battery voltage of the connected exchangeable energy storage devices and the voltage class of the electrical consumer. If the interface module is only operated with a single exchangeable energy storage device or a plurality of exchangeable energy storage devices connected in parallel, the defined voltage class of the electrical consumer is essentially the same as the battery voltage of the individual exchangeable energy storage device(s). In the case of a series connection of a number of exchangeable energy storage devices, the defined voltage class of the electrical consumer must essentially correspond to the sum of the battery voltages of the individual exchangeable energy storage devices.

To monitor the exchangeable energy storage device and to control or regulate the electrical consumer, the interface module comprises an interface to the electrical consumer, via which the exchangeable energy storage device and the electrical consumer can send and/or receive information, in particular about the at least one operating parameter. Accordingly, the electromechanical interfaces of the interface module and the exchangeable energy storage device also have at least one third contact, in the form of a signal or data contact, for transmitting the at least one operating parameter. In a preferred manner, the at least one operating parameter is designed as a voltage, a current, a current integral, a temperature, information about a temperature resistance, and/or information about a coding resistance, or other values for identifying the exchangeable energy storage device. If multiple operating parameters are used for monitoring, it is possible to use additional contacts of the electromechanical interfaces designed as signal or data contacts. Alternatively, it is also conceivable that the signal or data transmission in the sense of powerline communication is performed directly via the first and/or second power supply contact of the electromechanical interfaces. Corresponding methods for powerline communication are known to the skilled person and will not be further addressed herein.

In one further embodiment, the interface module comprises at least one switching element, in particular at least one MOSFET, by means of which the control or regulating unit of the interface module can temporarily or permanently interrupt the energy supply from the exchangeable energy storage device to the electrical consumer if the at least one operating parameter exceeds or falls below a limit value stored in a memory of the control or regulating unit and/or deviates from an expected value stored in the memory. This has the particular advantage of creating redundancy to the safety systems present in the electrical consumer and/or in the exchangeable energy storage device, which further increases operational reliability in the event of a fault. In addition, electrical consumers and/or exchangeable energy storage devices that do not have an integrated option for interrupting the energy supply are also able to be safely operated. The limit value can be designed as a minimum or maximum permitted voltage, a minimum or maximum permitted current or a maximum permitted temperature and the expected value as a current-time profile, a resistance value of the temperature resistor or the coding resistor, an identification value of the exchangeable energy storage device, or information about an interruption of the connection to the temperature resistor or the coding resistor.

In addition, it can be provided that the control or regulating unit, depending on the state of charge of a load capacitance of the electrical load, in particular a DC link capacitance of a power output stage, of the electrical consumer, effects start-up protection of the electrical consumer when energy is supplied again by the at least one switching element after an interruption and/or prevents the interface module from resetting itself. Therefore, the operator can, e.g., be protected from injury immediately after connecting an exchangeable energy storage device to a consumer that is still accidentally switched on. The operator is protected by the fact that the interface module is not reset automatically after a detected fault condition no longer exists as a result of, e.g., the temperature of the energy storage device returning to normal, the fault current dropping to almost zero or similar.

In order to protect the at least one switching element from excessively high load currents immediately after the electrical consumer is switched on by the operator, it is only switched on permanently when the charge state of the load capacity of the electrical consumer has risen to a defined threshold value, e.g. 90%. In order to precharge the load capacity of the electrical consumer before it is put into operation, the control or regulating unit of the interface module controls the at least one switching element in a clocked manner. Alternatively or additionally, a specially designed charging stage can also be provided in the interface module for precharging the load capacity.

If the electrical consumer comprises an electronic unit that can be woken up, the interface of the interface module can, in a particularly advantageous way, send a wake-up signal to the electronic unit of the electrical consumer via an enable contact and/or wake-up contact configured as an open collector output. This is particularly useful if the electronic unit of the electrical consumer is to be woken up by connecting the exchangeable energy storage device in order to achieve a particularly fast response to the operation of the main switch.

The interface module comprises an optical, acoustic and/or haptic display to indicate to the operator any error states detected by the interface module and/or an interruption in the power supply to the electrical consumer. This can, e.g., be designed as an HMI (Human Machine Interface) in the form of an LC, LED, OLED, AMOLED display or similar. A simple, especially multicolored, LED can also serve as a simple HMI. A dynamic loudspeaker or piezo for the acoustic display or a vibration motor for the haptic display are also conceivable. It can also be provided that the display means of the interface module is used to display operating and/or fault states of the electrical consumer. This is particularly advantageous if the electrical consumer itself does not have a corresponding display device.

To ensure that the interface module can be used as flexibly and universally as possible for a wide variety of electrical consumers, it can be designed as an exchangeable adapter. The adapter can either be replaced by the operator without tools or only by the manufacturer or an authorized dealer using a suitable tool. In the case of tool-free exchangeability, it makes sense for the adapter to have two electromechanical interfaces that are compatible with the electromechanical interface of the exchangeable energy storage device on the one hand and with the electromechanical interface of the electrical consumer on the other. The second electromechanical interface between the interface module and the electrical consumer comprises the interface mentioned in the introductory section, in particular for the bidirectional exchange of information.

The invention also relates to a method for controlling an electrical consumer by means of the interface module according to the invention, comprising at least the following steps:
actuating a main switch of the electrical consumer to wake up a control or regulating unit of the interface module,
switching on at least one switching element, in particular at least one MOSFET, of the interface module for the energy supply from an energy storage device connected to the electrical consumer to the electrical consumer,
switching on an electrical load of the electrical consumer if the at least one detected operating parameter fulfills an expected value stored in a memory of the control or regulating unit of the interface module and/or is within stored limit values.

A particular advantage of this is that it enables a simple and safe wake-up procedure for the operator to start up the electrical consumer. In addition, a redundant safety concept can be implemented for the electrical consumer and the associated exchangeable energy storage device.

In addition, at least the following steps are provided after the at least one switching element is switched on:
waking up an electronic unit of the electrical consumer,
interrogating at least one operating parameter recorded in the interface module by the electronic unit of the electrical consumer or transmission of the at least one operating parameter recorded in the interface module to the electronic unit of the electrical consumer, and
switching on the electrical load of the electrical consumer by the electronic unit of the electrical consumer if the at least one operating parameter detected fulfills an expected value stored in a memory of the control or regulating unit of the interface module and/or lies within stored limit values.

In particular for electrical consumers that already have an integrated electronic unit for controlling the electrical load, safe operation of the exchangeable energy storage device can be enabled in this way in conjunction with the interface module.

In a further method step, it is provided that a load capacitance, in particular a DC link capacitance of a power output stage, of the electrical consumer is precharged before the permanent closing of the at least one switching element with the advantages previously mentioned hereinabove.

In addition, in order to further improve operational safety, the energy supply from the energy storage device to the electrical consumer can be interrupted in a further step by opening the at least one switching element and/or the interface module can send a switch-off command via an enable contact to the electronic unit of the electrical consumer as soon as the at least one operating parameter detected does not meet the expected value stored in the memory of the control or regulating unit of the interface module and/or is outside the stored limit values. If the electronic unit of the electrical consumer then does not respond to the switch-off command from the interface module, the interface module in turn opens the at least one switching element to interrupt the energy supply in the sense of a redundant safety level. In the event of a short circuit, however, the power supply is immediately interrupted independently of the electronic unit of the electrical consumer.

In a further step, the at least one switching element is opened to interrupt the energy supply if the discharge current has not fallen to approximately zero for a defined period of time after the electrical consumer has been switched off Δny fault currents can thus be detected with particular advantage.

Furthermore, it is provided that the interface module is supplied with energy for a follow-up time, in particular between five and fifteen minutes, after the main switch is released in one step of the method, before the control or regulating unit of the interface module opens the at least one switching element to interrupt the energy supply to the electrical consumer. On the one hand, this ensures a very fast return to service within the run-on time and, on the other hand, reliable monitoring of the operating parameters, even after the electrical consumer has been switched off.

### EXEMPLARY EMBODIMENTS

### Drawings

The invention is explained hereinafter with reference to FIGS. 1 to 6 by way of example, whereby identical reference characters in the drawings indicate identical components having an identical function.

Shown are:

FIG. 1: a schematic representation of an exchangeable energy storage device that can be discharged by means of different electrical consumers of a defined voltage class that are directly incompatible with the exchangeable energy storage device and charged by means of a charger,

FIG. 2: a block diagram of the exchangeable energy storage device, the electrical consumer directly incompatible with the exchangeable energy storage device, and an interface module according to the invention,

FIG. 3: a schematic representation of the interface module accommodated in the electrical consumer,

FIG. 4: a schematic representation of the interface module designed as an exchangeable adapter on an electrical consumer designed as a hammer drill,

FIG. 5: a first embodiment of an electromechanical interface of the interface module or the adapter in a schematic representation and

FIG. 6: a schematic representation of a second embodiment of the electromechanical interface of the interface module or adapter.

### DESCRIPTION OF THE EXEMPLARY EMBODIMENTS

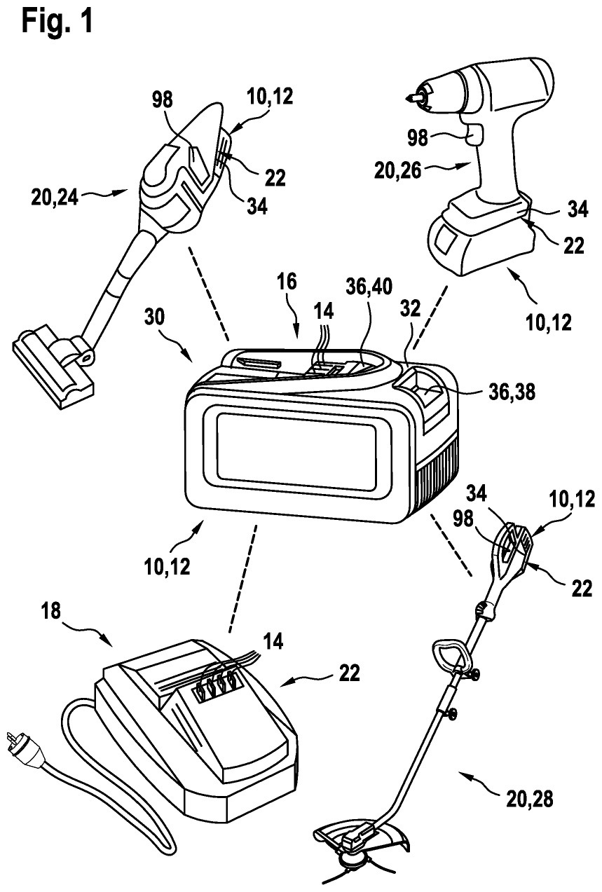

FIG. 1 shows an exchangeable energy storage device 10 in the form of a rechargeable battery pack 12 with an electromechanical interface 16 having a plurality of electrical contacts 14.

The exchangeable battery pack 12 can be charged by means of a charger 18 and discharged by various electrical consumers 20. For this purpose, the charger 18 and the electrical consumers 20 must each have a further electromechanical interface 22 having a plurality of electrical contacts 14, which is both electrically and mechanically compatible with the electromechanical interface 16 of the removable battery pack 12. FIG. 1 is intended to illustrate that the invention is suitable for a wide variety of electrical consumers 20. A cordless vacuum cleaner 24, a cordless impact wrench 26, and a cordless grass trimmer 28 are shown by way of example. In the context of the invention, however, other power tools, measuring devices, garden tools, and household appliances are also potential electrical consumers 20.

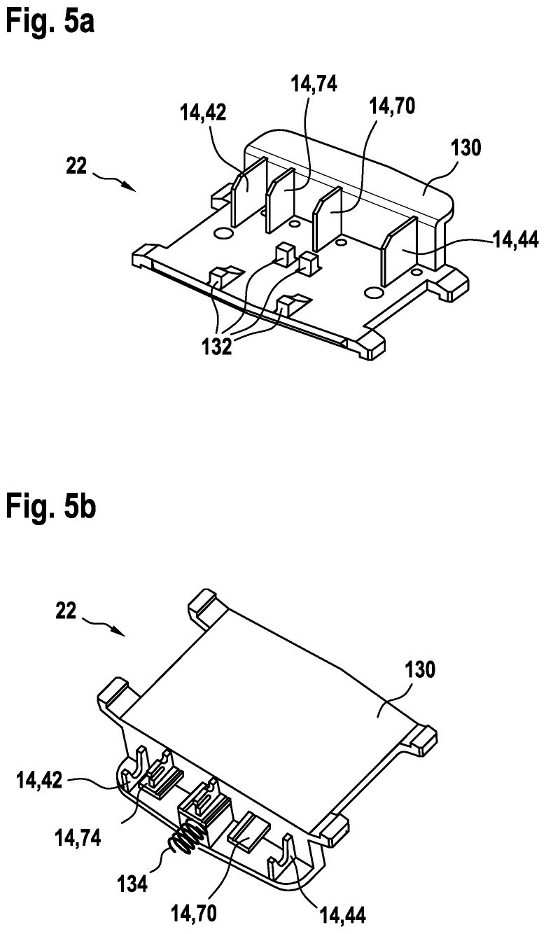

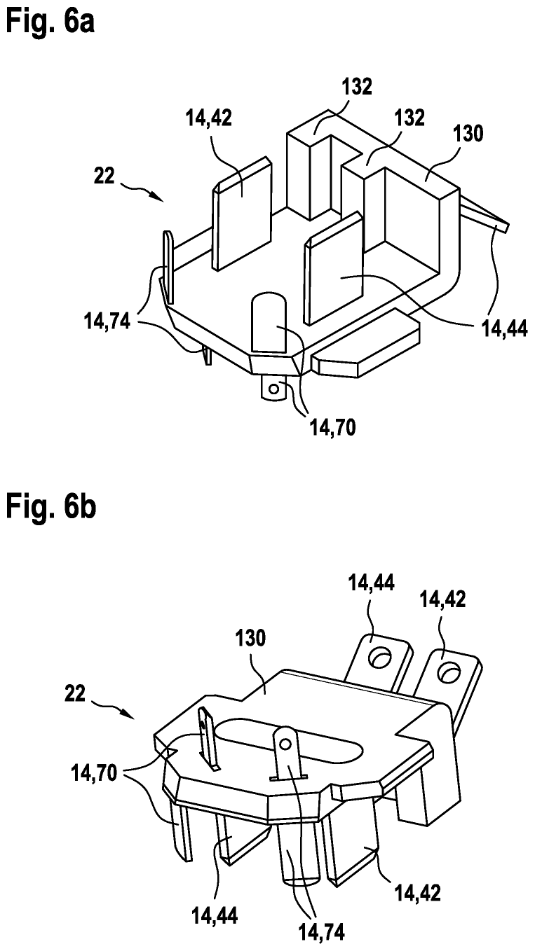

The interchangeable battery pack 12 comprises a housing 30, which comprises the electromechanical interface 16 on a side wall or on its upper side 32 for tool-free detachable connection to the compatible, further electromechanical interface 24 of the charger 18 or the electrical consumers 20. In conjunction with the electrical consumer 20, the electromechanical interfaces 16, 22 are primarily used to discharge the removable battery pack 12, whereas in conjunction with the charger 18 they are used to charge the removable battery pack 10. The exact design of the electromechanical interfaces 16, 22 depends on various factors, e.g. the voltage class of the electrical consumer 20, the charger 18 and the removable battery pack 12, as well as various manufacturer specifications. For example, two or more electrical contacts 14 can be provided for transferring energy and/or data between the removable battery pack 12 and the charger 18 or the electrical consumer 20. Mechanical coding is also conceivable so that the interchangeable battery pack 12 can only be operated on certain electrical consumers 20. Corresponding exemplary embodiments are shown below in FIGS. 5 and 6.

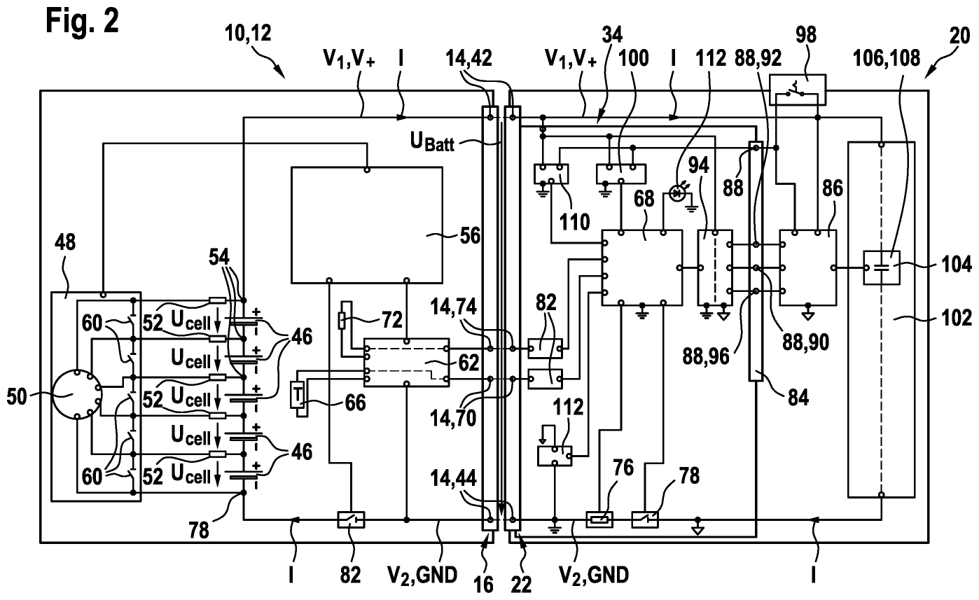

As mentioned in the introductory portion, different manufacturers of electrical consumers 20 have increasingly joined together to form so-called battery alliances, in which the electrical consumers 20 of the different manufacturers use a common energy storage platform in order to be able to offer the customer the widest possible range of electrical consumers 20 on the one hand and to be able to use an already successful and established concept of exchangeable battery packs 12 from a specific manufacturer on the other. However, the problem often arises that the electromechanical interfaces of the electrical consumers 20 of one manufacturer and the electromechanical interface 16 of the interchangeable battery packs 12 of the other manufacturer are incompatible with each other. It is therefore necessary to adapt the incompatible electrical consumers 20 to the common energy storage platform by means of an interface module 34 described below (see FIG. 2).

The interchangeable battery pack 12 comprises a mechanical locking device 36 for locking the positive and/or non-positive detachable connection of the electromechanical interface 16 of the interchangeable battery pack 12 to the corresponding mating interface 22 of the interface module 34 mounted on or in the electrical consumer 20. The locking device 36 is designed as a spring-loaded pusher 38, which is operatively connected to a locking member 40 of the interchangeable battery pack 12. Due to the spring action of the pusher 38 and/or the locking member 40, the locking device 36 engages automatically when the interchangeable battery pack 12 is inserted into the mating interface 22 of the interface module 34. If an operator presses the pusher 38 in the direction of insertion, the locking mechanism is released and the operator can remove or push out the interchangeable battery pack 12 from the electrical consumer 20 or the interface module 34 in the opposite direction to the direction of insertion.

FIG. 2 shows a block diagram consisting of the exchangeable energy storage device 10 in the form of an exchangeable battery pack 12 on the left-hand side and an electrical consumer 20 on the right-hand side, which is normally incompatible with the exchangeable battery pack 12. In order to establish compatibility between the removable battery pack 12 and the electrical consumer 20, the electrical consumer 20 comprises the interface module 34, which is designed, for example, as a printed circuit board with corresponding electronic components and a mating interface 22 that matches the electromechanical interface 16 of the removable battery pack.

The mutually compatible electromechanical interfaces 16 and 22 are each provided with a plurality of electrical contacts 14, a first of the electrical contacts 14 serving as a power supply contact 42 to which a first reference potential V₁, preferably a supply potential V₊, can be applied and a second of the electrical contacts 14 serving as a power supply contact 44 to which a second reference potential V₂, preferably a ground potential GND, can be applied. Via the first and second power supply contacts 42, 44, the alternating battery pack 12 can be discharged by the electrical consumer 20 with a discharge current I on the one hand and charged by the charger 18 with a charging current (not shown in FIG. 2) on the other. The current strengths of the charge and the discharging current can differ significantly from one another. The discharging current can, e.g., be up to ten times higher than the charging current of the charger 18 with appropriately designed electrical consumers 20. The term “loadable” is intended to clarify that the potentials V₊ and GND are not permanently applied to the power supply contacts 42, 44, but only after the electromechanical interfaces 16, 22 of the removable battery pack 12 and the interface module 34 have been connected. The same applies to a discharged exchangeable battery pack 12 after connection to the charger 16.

The removable battery pack 12 comprises a plurality of energy storage cells 46, which are shown in FIG. 2 as a series connection, but which can alternatively or additionally also be operated in a parallel connection, the series connection defining the battery voltage U_{Batt} or voltage class of the removable battery pack 12 dropping across the energy supply contacts 42, 44, whereas a parallel connection of individual energy storage cells 46 primarily increases the capacity of the removable battery pack 12. As previously mentioned, individual cell clusters consisting of energy storage cells 46 connected in parallel can also be connected in series in order to achieve a specific battery voltage U_{Batt} of the alternating battery pack 12 with simultaneously increased capacity. With conventional Li-ion energy storage cells 46 with a cell voltage U_{Cell} of 3.6 V each, a battery voltage U_{Batt}=V1−V2 of 5−3.6 V=18 V drops across the energy supply contacts 42, 44 in the present exemplary embodiment. Depending on the number of energy storage cells 46 connected in parallel in a cell cluster, the capacity of common interchangeable battery packs 12 can be up to 12 Ah or more. However, the invention is not dependent on the type, design, voltage, current delivery capacity, etc. of the energy storage cells 46 used, but can be applied to any interchangeable battery packs 12 and energy storage cells 46.

An SCM pre-stage 48 (single-cell monitoring) is provided for monitoring the individual, series-connected energy storage cells 46 or cell clusters of the alternating battery pack 12. The SCM pre-stage 48 comprises a multiplexer measuring device 50, which can be connected via filter resistors 52 with high impedance to corresponding taps 54 of the poles of the energy storage cells 46 or cell clusters. The term “energy storage cell” will hereinafter also include the cell cluster because these only have an influence on the capacity of the alternating battery pack 12, but are equally important for recording the cell voltages U_{Cell}. The filter resistors 54, which are designed to have a particularly high impedance, can prevent dangerous heating of the measuring inputs of the multiplexer measuring device 50, especially in the event of a fault.

The multiplexer measuring device 50 can be switched via a monitoring unit 56 integrated in the interchangeable battery pack 12 or directly within the SCM pre-stage 50. In addition, switching elements 60 of the SCM pre-stage 50 connected in parallel to the energy storage cells 46 can be closed or opened in this way in order to effect what is referred to as balancing of the energy storage cells 46 in order to achieve uniform charging or discharging states of the individual energy storage cells 46. It is also conceivable that the SCM pre-stage 50 passes the measured cell voltages U_{Cell} to the monitoring unit 56, so that the actual measurement of the cell voltages U_{Cell} is performed directly by the monitoring unit 56, e.g. via corresponding analog-to-digital converters (ADC).

The monitoring unit 56 can be designed as an integrated circuit in the form of a microprocessor, ASIC, DSP, or the like. However, it is also conceivable that the monitoring unit 56 consists of multiple microprocessors or at least partly of discrete components with corresponding transistor logic. The monitoring unit 56 can further comprise a memory for storing at least one operating parameter of the alternating battery pack 12, e.g. the battery voltage U_{Batt}, the cell voltages U_{Cell}, the charging or discharging current I, a current integral, a temperature T, or the like.

A temperature sensor 66 arranged in the removable battery pack 12, which is preferably designed as an NTC and is in close thermal contact with at least one of the energy storage cells 46, is used to measure the temperature T of the removable battery pack 12 or the energy storage cells 46 by means of a measuring circuit 64 integrated into the removable battery pack 12. The temperature T measured in this way can then be evaluated by a control or regulating unit 68 of the interface module 34 via a first contact 14 of the electromechanical interfaces 16, 22, which is designed as a signal or data contact 70.

In order for the interface module 34 of the electrical consumer 20 to be able to identify the removable battery pack 12 and optionally release it for discharging, the removable battery pack 12 comprises a coding resistor 72, which is connected to the measuring circuit 62. The resistance value of the coding resistor 72 measured by the measuring circuit 62 can then be evaluated by the control or regulating unit 68 of the interface module 34 via a further contact 14 of the electromechanical interfaces 16, 22 designed as a signal or data contact 74. If the resistance value of the coding resistor 72 matches an expected value stored in a memory of the control or regulating unit 68 of the interface module 34, the discharging process of the removable battery pack 12 is enabled by the control or regulating unit 68 of the interface module 34. Instead of just one coding resistor 72, multiple coding resistors can also be provided in the alternating battery pack 12, each for the charging and discharging process. If the measured resistance values of the coding resistors do not match the expected values according to the look-up table, then the charging or discharging process of the exchangeable battery pack 12 is aborted or not permitted. With particular advantage, this enables the operation of interchangeable battery packs 12 of different power classes with identical electromechanical interfaces 16 or 22.

In addition to the measured temperature T or the resistance value of the temperature sensor 66 and/or the coding resistor 72, the first and/or second signal or data contact 70 or 74 can also be used to transmit the other operating parameters previously mentioned from the removable battery pack 12 to the interface module 34 for evaluation there by means of the control or regulating unit 68. In addition, the signal or data contacts 70 or 74 can also be bidirectional for the mutual exchange of information between the interchangeable battery pack 12 and the electrical consumer 20. In this way, the interface module 44 can control the interchangeable battery pack 12 via the monitoring unit 56 there or, optionally, also directly if the at least one operating parameter exceeds or falls below a limit value stored in the memory of the control or regulating unit 68 of the interface module 34 and/or deviates from an expected value stored in the memory. For example, a shunt resistor 76 of the interface module 34 is used to measure the discharge current I. In addition, the interface module 34 can have a temperature sensor (not shown) for measuring the temperature T. Direct measurement of the battery voltage U_{Batt} applied to the power supply contacts 42, 44 of the interface module 34 by means of the control and regulating unit 68 is also conceivable. Consequently, the limit value can be a minimum or maximum permitted voltage value, a minimum or maximum permitted current value or a maximum permitted temperature value and the expected value can be a current-time profile, a resistance value of the temperature resistor 66 or the coding resistor 72, another identification value of the removable battery pack 12 or information about an interruption of the connection to the temperature resistor 66 or the coding resistor 72. It is also conceivable that the signal or data transmission is performed via the first and/or second power supply contact 42, 44 in the sense of powerline communication instead of via the additional signal or data contacts 70, 74.

If, for example, the discharge current I measured by the shunt resistor 76 exceeds a maximum permitted current value or if the battery voltage U_{Batt} measured by the control or regulating unit 68 of the interface module 34 is outside the voltage class of the electrical consumer 20, i.e. below a minimum permissible or above a maximum permissible voltage value, the discharge current I from the alternating battery pack 12 to the electrical consumer 20 can be interrupted temporarily or permanently by the control or regulating unit 68 of the interface module 34 opening a switching element 78 in the ground path (low-side) of the interface module 34. However, it is also conceivable that one or more switching elements 78 are arranged in the supply path (high-side). Similarly, at least one switching element 78 can be provided in both the supply path and the ground path. Preferably, the switching element 78 is designed as a MOSFET, although other switching elements, e.g., a relay, an IGBT, a bipolar transistor, or the like are also conceivable. As a result, the interface module 34 can also be used to safely operate electrical consumers 20 and/or exchangeable energy storage devices 10 that do not have an integrated option for interrupting the energy supply. As shown in FIG. 2, the alternating battery pack 12 itself can also comprise a corresponding switching element 80 for interrupting the discharging or charging current I, which is controlled by the monitoring unit 56 there. The latter then receives a corresponding switching command from the control or regulating unit 68 of the interface module 68 via the at least one contact 14 of the electromechanical interfaces 16, 20 of the removable battery pack 12 and the interface module 34, which is formed as a signal or data contact 70, 72. In order to adapt the signals or data transmitted via the signal or data contacts 70, 72 between the monitoring unit 56 or the measuring circuit 62 of the interchangeable battery pack 12 and the control or regulating unit 68 of the interface module 34, the interface module 34 comprises corresponding analog or analog-to-digital converters 82, which are each connected between the signal or data contacts 70, 72 and the control or regulating unit 68.

To control or regulate the electrical consumer 20, the control or regulating unit 68 of the interface module 34 is connected to an electronics unit 86 of the electrical consumer 20 via a further interface 84. For this purpose, the further interface 84 comprises contact points 88 which are, e.g., designed as solder or plug contacts of the interface module 34, which is designed as a printed circuit board. A first of these contact points 88 serves as a data contact 90, in particular a bidirectional data contact, and a second contact point 88 serves as an enabling contact 92 between the electronics unit 86 and a protective circuit 94 of the interface module 34. The protective circuit 94 effects a level adjustment of any voltage differences between the electronic unit 86 of the electrical consumer 20 and the control or regulating unit 68 of the interface module 34. For this purpose, said circuit separates the corresponding signals from each other via two different ground potentials. These two ground potentials can also be electrically isolated from each other. While a first ground potential is at the ground potential GND of the alternating battery pack 12, the second ground potential is defined via the electrical consumer 20. The control or regulating unit 68 of the interface module 34 can optionally send a wake-up signal to the electronic unit 86 of the electrical consumer 20 via a third contact point 88 of the interface 84, which is designed as a wake-up contact 96, if the electronic unit 86 cannot be woken up directly via the enable contact 92. The outputs of the protective circuit 94 connected to the enable contact 92 or the wake-up contact 96 are preferably designed as open collector outputs, which pull the respective collector to the second ground potential of the electrical consumer 20 when the associated transistor closes.

To put the electrical consumer 20 into operation, the operator actuates a main switch 98 of the electrical consumer 20 (see also FIG. 1). As a result, the control or regulating unit 68 of the interface module 34 is awakened via a wake-up sleep detection circuit 100 connected to the main switch 98 by means of a fourth contact point 88 of the interface 84. The control or regulating unit 68 then closes the previously open switching element 78 of the interface module 34 in order to enable the energy supply from the interchangeable battery pack 12 to the electrical consumer 20. By waking up the control and regulating unit 68 of the interface module 34, the electronic unit 86 of the electrical consumer 20 is also woken up via the enable contact 92 or the wake-up contact 96. This is particularly useful if the electronic unit 86 of the electrical consumer 20 is to be woken up by plugging in the removable battery pack 12 in order to achieve a particularly fast response to the operation of the main switch 98.

Subsequently, the electronic unit 86 interrogates the at least one operating parameter detected by the interface module 34 or the interface module 34 in turn transmits the at least one detected operating parameter to the electronic unit 86. If the at least one detected operating parameter is within the limit values stored in the memory of the control or regulating unit 68 of the interface module 34 or fulfills an expected value stored therein, the electronic unit 86 of the electrical consumer 20 switches on an electrical load 102 connected to the first and second power supply contacts 42, 44 of the electromechanical interface 22 of the interface module 34, to which the battery voltage U_{Batt} is applied. The electrical load 102 can, e.g., be in the form of a brushless DC motor (EC or BLDC motor; not shown) of the cordless vacuum cleaner 24, the cordless impact screwdriver 26, or the cordless grass trimmer 28, which is controlled by means of a power output stage 104 via pulse width modulation (PWM). A detailed description of these devices will not be provided because these are sufficiently known to the skilled person and are therefore not essential to the invention. The power output stage 104 can be a B6 bridge or the like, which controls a three-phase BLDC motor in a pulse-width modulated manner to change its speed and/or torque, which has a direct influence on the discharge current I of the alternating battery pack 12. The power output stage 104 normally features a load capacitance 108 in the form of a DC link capacitance 106. However, the invention is neither limited to electric motor-driven loads 102 in general, nor to BLDC motors controlled by a power output stage 104 in particular. The electric load 102 can thus also be in the form of a brushed electric motor, or be non-motorized. Numerous embodiments of possible electrical loads are known to the skilled person, so they will not be addressed in detail herein.

In the event that the electrical consumer 20 itself does not comprise an electronic unit 86, it can alternatively also be provided that the control or regulating unit 68 of the interface module 34 switches on the electrical load 102 in the electrical consumer 20 if the at least one operating parameter detected fulfills an expected value stored in the memory of the control or regulating unit 68 and/or lies within stored limit values.

In order to protect the operator from injury immediately after connecting the interchangeable battery pack 12 to an electrical consumer 20 that is still accidentally switched on, the control or regulating unit 68 of the interface module 34 can effect start-up protection via the electronic unit 86 of the electrical consumer 20 by means of a start-up protection circuit 110 depending on the charge state of the load capacity 108. In addition or alternatively, the start-up protection circuit 110 can also be used to prevent the interface module 34 from resetting itself. In this way, it can be ensured that a power supply interrupted by the switching element 78 of the interface module 34 as a result of a detected fault state is restored by an automatic closing of the switching element 78 after the fault state has been eliminated because, e.g., the temperature T or a fault current of the AC battery pack 12 has fallen below the respective limit value again.

Furthermore, in order to also protect the switching element 78 of the interface module 34 from an excessively high discharge current I immediately after the electrical consumer 20 is switched on by the operator, the switching element 78 is only switched on permanently when the charge state of the load capacity 108 of the electrical consumer 20 has risen to a defined threshold value, e.g. 90%. For this purpose, the control or regulating unit 68 of the interface module 34 controls the at least one switching element 78 after actuation of the main switch 98 in a clocked manner until the defined threshold value for the state of charge is reached. Alternatively or additionally, a specially designed charging stage 112 can also be provided in the interface module 34 for clocked or unclocked precharging of the load capacity 108.

A further protective measure results from the fact that the energy supply is interrupted by the opening of the switching element 78 if the discharge current I has not fallen to approximately zero for a defined period of time T_{off} after the electrical consumer 20 has been switched off. Any fault currents are able to be detected as a result.

It is further provided that the interface module 34 is still supplied with energy for a follow-up time Tₚₒₛₜ, in particular between 5 and 15 minutes, after the main switch 98 is released, before the control or regulating unit 68 of the interface module 34 opens the at least one switching element 78 to interrupt the energy supply to the electrical consumer 20. On the one hand, this ensures very fast recommissioning within the run-on time Tpost and, on the other hand, reliable monitoring of the operating parameters even after the electrical consumer 20 has been switched off.

In order to indicate to the operator any error states detected by the interface module 34 and/or an interruption in the power supply to the electrical consumer 20, the interface module 34 has an LED 112, which is preferably provided at a location of the electromechanical interface 22 of the interface module 34 that is clearly visible from the outside. However, other optical, acoustic, and/or haptic display means are also suitable, e.g. an HMI (Human Machine Interface) in the form of an LC, LED, OLED, AMOLED display or similar, a dynamic speaker or piezo, and/or a small vibration motor. It is also conceivable that display means already contained in the electrical consumer 20 are used, which can be controlled via the control and regulating unit 68 of the interface module 34 and the electronic unit 86 of the electrical consumer 20. It can also be provided that the display means of the interface module 34 is used to display operating and/or fault states of the electrical consumer 20. This is particularly useful if the electrical consumer itself does not have a corresponding display device.

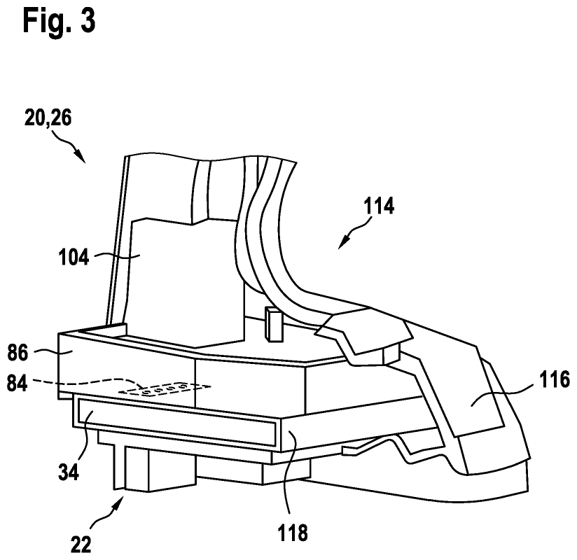

FIG. 3 shows a section through the base 114 of the electrical consumer 20, which is designed as a drill impact wrench 26. The interface module 34 together with the associated electromechanical interface 22 is received in a half-shell 116 of the base 114 in such a way that the exchangeable battery pack 12 (not shown) can be inserted along with its electromechanical interface 16 directly into the base 114 and then latched there with its locking member 40 in a recess (not shown) of the electromechanical interface 22 of the interface module 34, which is only shown schematically. The interface module 34 is designed as a molded circuit board 118, which is electrically connected to the electronic unit 86 of the impact wrench 26 via the interface 84. The power output stage 104 is only indicated as a component of the electrical load 102. However, the design of the impact wrench 26 is known to the skilled person, so it will not be further addressed at this point.

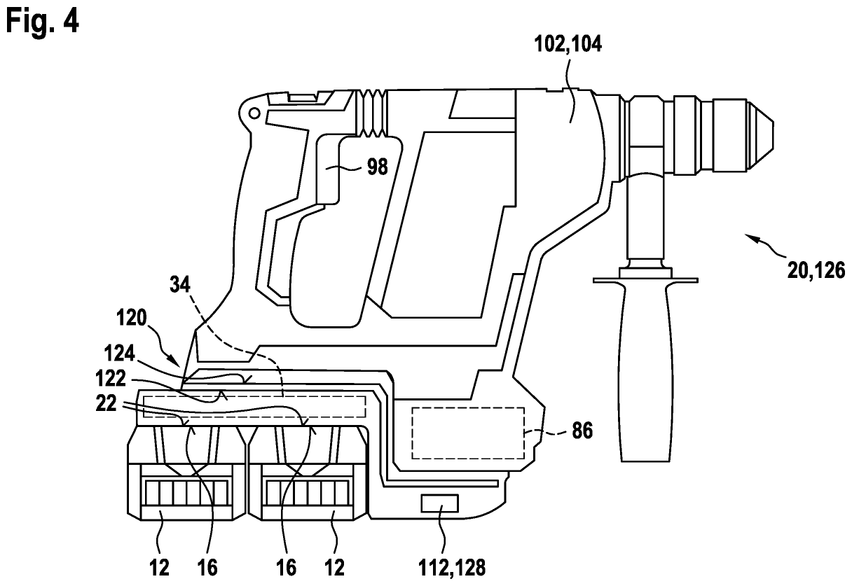

So that the interface module 34 can be used flexibly and universally for a wide variety of electrical consumers 20, it is designed in FIG. 4 as an adapter 120 that can be exchanged without tools. The adapter 120 has at least two different electromechanical interfaces 22, 122, whereby the first electromechanical interface 22 is compatible with the electromechanical interface 16 of the interchangeable battery pack 12 and the at least one second electromechanical interface 122 is compatible with an electromechanical interface 124 of the electrical consumer 20 designed as a hammer drill 126. The at least one second electromechanical interface 122 comprises the electrical contact points 88 of the interface 84 for this purpose. A particularly high degree of flexibility can be achieved if the at least one second electromechanical interface 122 of the adapter 120 is designed to be exchangeable on the adapter 120 for different electrical consumers 20. In this case, however, it is possible that the at least one second electromechanical interface 122 can only be replaced by the manufacturer. It is also conceivable that the complete adapter 120 can only be replaced by the manufacturer of the electrical consumer 20 using the appropriate tools. Compared to the interface module 34 designed as a molded printed circuit board 118, this has the additional advantage that the interface module 34 can be more easily replaced by the manufacturer of the electrical consumer 20. The electrical consumer 20 can thus be retrofitted to its original electromechanical interface 124 more quickly.

FIG. 4 also shows the option of designing the adapter 120 such that it has two first electromechanical interfaces 22 for two interchangeable battery packs 12 connected in parallel or in series, each with the same battery voltage U_{Batt}, for particularly powerful electrical consumers 20 of a defined voltage class. In the case of a parallel connection of the two interchangeable battery packs 12, the voltage class of the electrical consumer 20 must then correspond to the respective battery voltage U_{Batt} of a single interchangeable battery pack 12, while the voltage class of the electrical consumer 20 must be twice as high as the battery voltage U_{Batt} of a single interchangeable battery pack 12 when the two interchangeable battery packs 12 are connected in series. Accordingly, electronics must then also be provided in the adapter 120 or in the interface module 34, which is suitable for managing the two interchangeable battery packs 12. In addition, the electronics are advantageously able to compensate for certain voltage deviations between the resulting battery voltage U_{Batt} of the connected alternating battery packs 12 and the defined voltage class of the electrical consumer 20. However, since such electronics are known to the skilled person, this will not be addressed in detail.

In order to indicate to the operator any fault conditions detected by the interface module 34 of the adapter 120 and/or an interruption of the energy supply to the electrical consumer 20, the adapter 120 comprises an optical, acoustic and/or haptic display means 128, which can be in the form of the LED 112 previously mentioned hereinabove or another suitable HMI. Here too, the display means 128 of the adapter 120 can additionally be used to display operating and/or error states of the rotary hammer 126, in particular if the latter does not comprise its own corresponding display means.

FIGS. 5 and 6 show two possible embodiments of the electromechanical interface 22 of the interface module 34 or the adapter 120 for tool-free connection with different interchangeable battery packs 12 for two different battery voltages U_{Batt} or voltage classes. In FIG. 5, the electromechanical interface 22 is, e.g., designed for a battery voltage U_{Batt} of 18 V and in FIG. 6 for a battery voltage U_{Batt} of 10.8 V.

The electromechanical interfaces 22 each comprise the electrical contacts 14 shown in FIG. 2, a first of the electrical contacts 14 serving as a power supply contact 42 to which the first reference potential V1, preferably the supply potential V₊, can be applied, a second of the electrical contacts 14 serving as a power supply contact 44 to which the second reference potential V₂, preferably the ground potential GND, can be applied, and a third and fourth of the electrical contacts 14 each serving as a signal or data contact 70 and 74. The electrical contacts 14 are attached to a contact carrier 130, which is preferably made of plastic, or are partially molded around it. The contact carrier 130 further comprises mechanical codings 132, so the electromechanical interface 22 is only compatible with interchangeable battery packs 12 of a certain voltage and/or power class.

In contrast to the contact holder 130 shown in FIG. 6, the contact holder 130 shown in FIG. 5 is resiliently mounted on the interface module 34 or adapter 120 via a compression spring 134, so that the electromechanical interface 22 is better protected against vibrations during operation of the electrical consumer 20. This is particularly advantageous for electrical consumers 20 in higher power classes.

Similar to the electromechanical interface 22, the second electromechanical interface 122 of the adapter 120 indicated in FIG. 4 can also be designed. However, its structure depends largely on the design of the electromechanical interface 124 of the electrical consumer 20.

Finally, it should be pointed out that the invention is not limited to the shapes and proportions of the exemplary embodiments shown in FIGS. 1 to 6, nor to the exemplary values and figures specified in the description.

1. An interface module for operating an electrical consumer of a defined voltage class with at least one exchangeable energy storage device that is directly incompatible with the electrical consumer, comprising:
a control or regulating unit,
wherein the defined voltage class of the electrical consumer corresponds to an integer multiple of a battery voltage of the at least one exchangeable energy storage device, and
wherein the control or regulating unit is configured (i) to monitor at least one operating parameter of the at least one exchangeable energy storage device, and (ii) to control an electrical load of the electrical consumer as a function of the monitored at least one operating parameter.

2. The interface module according to claim 1, further comprising:
an interface to the electrical consumer through which the at least one exchangeable energy storage device and the electrical consumer send and/or receive information about the at least one operating parameter.

3. The interface module according to claim 1, wherein the at least one operating parameter is a voltage, a current, a current integral, a temperature, information about a temperature resistor, and/or information about a coding resistor, or other values for identifying the at least one exchangeable energy storage device.

4. The interface module according to claim 3, further comprising:
at least one switching element,
wherein the control or regulating unit is configured to use the at least one switching element to temporarily or permanently interrupt an energy supply from the at least one exchangeable energy storage device to the electrical consumer, when the at least one operating parameter exceeds or falls below a limit value stored in a memory of the control or regulating unit and/or deviates from an expected value stored in the memory.

5. The interface module according to claim 4, wherein:
the limit value is a minimum or maximum permissible voltage, a minimum or maximum permissible current or a maximum permissible temperature, and
the expected value is a resistance value of the temperature resistor or of the coding resistor, or information about an interruption of the connection to the temperature resistor or to the coding resistor.

6. The interface module according to claim 4, wherein the control or regulating unit, depending on a state of charge of a load capacitance of the electrical load of the electrical consumer, effects start-up protection of the electrical consumer when energy is supplied again by the at least one switching element after an interruption and/or prevents the interface module from resetting itself.

7. The interface module according to claim 6, wherein the control or regulating unit is configured to control the at least one switching element in a clocked manner in order to effect a precharging of the load capacity of the electrical consumer before the electrical consumer is put into operation.

8. The interface module according to claim 2, wherein the interface comprises an enable contact and/or wake-up contact configured as an open collector output for sending a wake-up signal to an electronic unit of the electrical consumer.

9. The interface module according to claim 1, further comprising:
a display configured to display a detected fault state and/or an interruption of the power supply to the electrical consumer.

10. The interface module according to claim 1, further comprising:
an electromechanical interface compatible with an electromechanical interface of the exchangeable energy storage device.

11. The interface module according to claim 2, wherein:
the interface module is configured as an exchangeable adapter for the electrical consumer, and
the exchangeable adapter comprises a first electromechanical interface compatible with an electromechanical interface of the at least one exchangeable energy storage device and a second electromechanical interface compatible with an electromechanical interface of the electrical consumer, which comprises the interface.

12. A method for controlling an electrical consumer using an interface module, comprising:
actuating a main switch of the electrical consumer to wake up a control or regulating unit of the interface module;
switching on at least one switching element of the interface module for an energy supply from at least one exchangeable energy storage device connected to the electrical consumer to the electrical consumer; and
switching on an electrical load of the electrical consumer when if the at least one detected operating parameter fulfills an expected value stored in a memory of a control or regulating unit of the interface module and/or lies within stored limit values,
wherein the electrical consumer is of a defined voltage class,
wherein the at least one exchangeable energy storage device is directly incompatible with the electrical consumer,
wherein the defined voltage class of the electrical consumer corresponds to an integer multiple of a battery voltage of the at least one exchangeable energy storage device, and
wherein the interface module includes a control or regulating unit is configured (i) to monitor the at least one operating parameter of the at least one exchangeable energy storage device, and (ii) to control the electrical load of the electrical consumer as a function of the monitored at least one operating parameter.

13. The method according to claim 12, wherein the following happens after switching on the at least one switching element:
waking up an electronic unit of the electrical consumer,
interrogating the at least one operating parameter detected in the interface module by the electronic unit of the electrical consumer or transmitting the at least one operating parameter detected in the interface module to the electronic unit of the electrical consumer, and
switching on the electrical load of the electrical consumer by the electronic unit of the electrical consumer when if the at least one detected operating parameter fulfills an expected value stored in the memory of the control or regulating unit of the interface module and/or lies within stored limit values.

14. The method according to claim 12, further comprising:
precharging a load capacitance of the electrical load of the electrical consumer before the switching element is permanently closed.

15. The method according to claim 12, further comprising:
interrupting the energy supply from the energy storage device to the electrical consumer by opening the at least one switching element; and/or
sending, using the interface module, a switch-off command to the electronic unit of the electrical consumer via an enable contact configured as an open collector output, as soon as the at least one detected operating parameter does not fulfill the expected value stored in the memory of the control or regulating unit of the interface module and/or lies outside the stored limit values.

16. The method according to claim 12, further comprising:
opening the at least one switching element for interrupting the energy supply when the discharge current has not fallen to approximately zero for a defined period of time after the electrical consumer has been switched off.

17. The method according to claim 12, wherein the interface module is still supplied with energy for a follow-up time after the main switch has been released, and before the control or regulating unit of the interface module opens the at least one switching element for interrupting the energy supply to the electrical consumer.
